(19) United States
(12) Patent Application Publication
(10) Pub. No.: US 2006/0132318 A1
(43) Pub. Date: Jun. 22, 2006

(54) Self-propelled cleaner and self-propelled traveling apparatus

(75) Inventor: Akitaka Shimizu, Osaka (JP)

Correspondence Address: YOKOI & CO. U.S.A., INC., 13700 MARINA POINTE DRIVE #723, MARINA DEL RAY, CA, 90292, US

(73) Assignee: Funai Electric Co., Ltd., Osaka (JP)

(21) Appl. No.: 11/253,033

(22) Filed: Oct. 18, 2005

(30) Foreign Application Priority Data
Oct. 27, 2004 (JP) JP2004-312041

(51) Int. Cl. G08B 23/00; G05B 15/00; E01H 1/08

(52) U.S. Cl. 340/575; 15/340.1; 700/259

(57) ABSTRACT

Disclosed herein is a self-propelled traveling apparatus capable of precisely determining whether a human is sleeping or awake, thereby eliminating useless alarms. When a human is detected by one of four pyroelectric sensors, the body of the self-propelled traveling apparatus is turned so that a CCD camera faces the direction of a pyroelectric sensor that detected the human, and takes images of the human. Then, based on the imaging signal generated by the CCD camera, the movement and posture of the human is detected. When it is determined that the human is at rest and lying down, the human is considered sleeping and an alarm is sounded at a preset time.

### BACKGROUND OF THE INVENTION

1. Field of the Invention

The present invention relates to a self-propelled cleaner and a self-propelled traveling apparatus, and more specifically, a self-propelled cleaner and a self-propelled traveling apparatus which are equipped with an alarm function that makes a sound or the like to give an alarm or inform the current time at a preset time.

2. Description of the Prior Art

Conventionally, there is known an alarm clock that has a sensor to detect a human body which gives an alarm only when a human body is detected by the sensor (for example, refer to Japanese Utility Model Laid-open No. H4-29893 and Japanese Patent Laid-Open Nos. H5-87960 and H7-174870). According to such an alarm clock, it is possible to control the alarm clock not to give an alarm even at a preset time if no human is present near the alarm clock.

However, the alarm clocks described in the Japanese Utility Model Laid-open Publication No. H4-29893 and Japanese Patent Laid-open Publication No. H5-87960 can detect the presence of a human, but give an alarm even when the human is awake or while the human is absent, thus causing a nuisance to the neighbors. Also, the alarm clock described in the Japanese Paten Laid-open H7-174870 is designed to detect the movements of a human, such as getting up or getting out of bed, but this alarm clock determines that a human is sleeping even when the human is reading a book lying in bed, for example. Therefore, this method of determining whether or not the human is sleeping lacks accuracy.

### SUMMARY OF THE INVENTION

The present invention has been made in view of the above problems, and therefore an object of the invention is to precisely determine whether or not a human is sleeping, and thereby to avoid useless alarms.

To achieve the above object, an embodiment of the present invention resides in a self-propelled traveling apparatus that includes: a drive mechanism to steer and drive the self-propelled traveling apparatus; and an alarm to give a predetermined alarm or information at a preset time, comprising: one or more human sensors; a camera with a predetermined viewing angle; and a sleep determination processor that, when a human is detected by the human sensor, takes images of the human, and also determines whether or not the human is sleeping, based on the imaging signals from the camera, wherein the alarm gives a predetermined alarm or information at the preset time when the sleep determination processor determines that the human is sleeping.

In the embodiment constructed as above, the self-propelled traveling apparatus comprises a drive mechanism to steer and drive the self-propelled traveling apparatus, and an alarm to give a predetermined alarm or information at a preset time, and further comprises human sensors and a camera with a predetermined viewing angle. That is, according to the present invention, it is possible to detect a human located nearby and also to take images of the human with the camera.

Furthermore, the self-propelled apparatus, when the human sensor detects a human, takes images of the human with the camera, and has a sleep determination processor that determines whether or not the human is sleeping, based on the imaging signals from the camera. In addition, the alarm gives the predetermined alarm at the preset time, when the sleep determination processor determines that the human is sleeping. That is, once the human sensor detects the presence of a human, it determines whether or not the human is sleeping, by means of the camera. Thus, by performing two steps of detection, i.e., whether or not a human is present and whether or not the detected human is sleeping, it is possible to improve the accuracy of the determination of whether or not the human is sleeping. Moreover, by giving a predetermined alarm, such as making a sound, only when the human is sleeping, useless alarms and resulting nuisance to the neighbors can be avoided.

As described above, this embodiment achieves the improvement of the determination of whether or not a human is sleeping, and also the elimination of useless alarms.

In another embodiment of the present invention, the sleep determination processor determines whether or not a human is sleeping, by checking whether or not the human is lying in bed, based on the imaging signals from the camera.

In the embodiment of the present invention as constructed above, it is possible to detect the posture of a human by analyzing the imaging signals from the camera, and to determine whether or not the human is sleeping, based on the detected posture. This enables precise determination of whether or not a human is sleeping.

In still another embodiment of the present invention, the sleep determination processor determines whether or not a human is sleeping by checking if the human is at rest, based on the imaging signals from the camera.

In the embodiment of the present invention as constructed above, it is possible to detect the movement of a human by analyzing the imaging signals from the camera, and to determine whether or not the human is sleeping, from a movement or no movement of the human. This allows precise determination of whether or not a human is sleeping.

In yet another embodiment of the present invention, a plurality of the human sensors are provided, and the human sensors are disposed roughly equiangularly.

When the sleep determination processor takes images of a human with the camera, the body is turned so that the camera faces the direction in which one of the plurality of human sensors that detected the human is disposed.

In the embodiment of the present invention as constructed above, it is possible to detect the presence of a human without fail even if the human is located in any direction around the body of the self-propelled traveling apparatus, by disposing the plurality of human sensors roughly equiangularly. Also, since the camera faces the direction in which the human is detected, it is possible to surely take an image of the human even if the human is detected in any direction.

In still another embodiment of the present invention, the self-propelled traveling apparatus of the invention is a self-propelled cleaner having a cleaning mechanism.

In the embodiment of the present invention as constructed above, cleaning can be done without having to carry a cleaner, thus easing the cleaning by the user.

### BRIEF DESCRIPTION OF THE DRAWINGS

Embodiments of the present invention will be described in detail based on the following figures, wherein:

FIG. 1 is an external perspective view of a self-propelled cleaner of the present invention;

FIG. 2 is a rear view of the self-propelled cleaner shown in FIG. 1;

FIG. 3 is a block diagram illustrating the configuration of the self-propelled cleaner shown in FIGS. 1 and 2;

FIG. 4 is a flowchart showing the flow of the alarm mode performing process executed by a self-propelled cleaner 10;

FIG. 5 shows the self-propelled traveling apparatus that is performing an automatic travel with its four pyroelectric sensors enabled;

FIG. 6 shows the self-propelled traveling apparatus that is performing an automatic travel with its four pyroelectric sensors enabled;

FIG. 7 shows changes in the frames of imaging signals generated by a CCD camera; and

FIG. 8 shows a frame (a) in which a human is lying down and a frame (b) in which a human is standing (b).

### DESCRIPTION OF THE PREFERRED EMBODIMENT

Embodiments of the present invention will be described below in this order:
(1) Appearance of the self-propelled cleaner
(2) Internal configuration of the self-propelled cleaner
(3) Operation of the self-propelled cleaner
(4) Modifications
(5) Conclusion

(1) Appearance of the Self-Propelled Cleaner

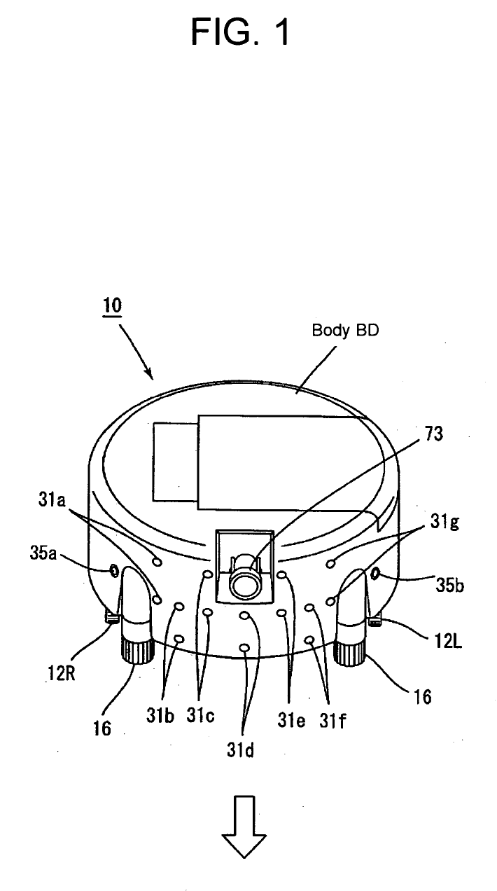

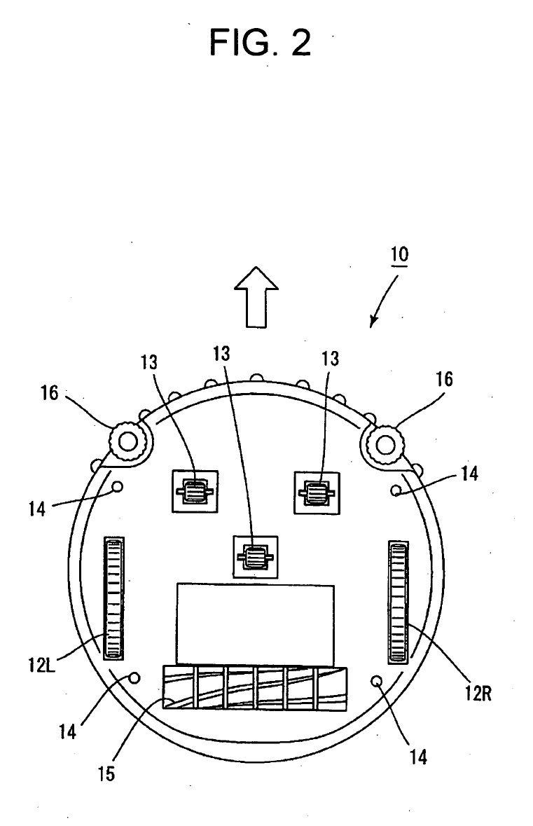

FIG. 1 is an external perspective view of a self-propelled cleaner according to the present invention, and FIG. 2 is a rear view of the self-propelled cleaner shown in FIG. 1. In FIG. 1, the direction shown by the arrow A is the direction in which the self-propelled cleaner travels forward. In the embodiments described below, self-propelled traveling apparatuses of the present invention are self-propelled cleaners having a cleaning mechanism, but the self-propelled traveling apparatus is not limited to the self-propelled cleaner, and the self-propelled traveling apparatus without the cleaning mechanism may be implemented. As shown in FIG. 1, the self-propelled cleaner 10 has a rough cylindrical body BD, and two drive wheels 12R and 12L (refer to FIG. 2) provided at the bottom of the body BD, which are individually driven to enable the body BD to move forward backward and turn. At the center of the body BD, an infrared CCD sensor 73 is provided as the camera. This allows taking images of the front part of the body BD with the predetermined viewing angle.

Moreover, seven ultrasonic sensors 31 (31a to 31g) are disposed below the CCD camera 73. Each of the ultrasonic sensors 31 comprises a transmitter that generates ultrasonic wave and a receiver that receives the ultrasonic wave transmitted from the transmitter and reflected from a wall in front thereof, and it is possible to calculate the distance to the wall, from the time during which an ultrasonic wave is transmitted from the transmitter and received by the receiver. Of these seven ultrasonic sensors 31, an ultrasonic sensor 31d is disposed at the center front of the body BD, and each pair of ultrasonic sensors 31a and 31g, 31b and 31f, and 31c and 31e is disposed symmetrically at the left and right sides of the body BD. When the body BD is traveling perpendicular to the front wall, the distances calculated by a symmetrically disposed pair of ultrasonic sensors are equal.

Also, at the right and left sides of the front of the body BD, pyroelectric sensors 35 (35a and 35b) are provided respectively as human sensors. The pyroelectric sensors 35a and 35b can detect a human located in the vicinity of the body BD by detecting infrared rays emitted from the human body. Also, pyroelectric sensors 35c and 35d, not shown in FIG. 1, are disposed at both sides of the rear of the body BD respectively. This realizes detection range of 360 degrees around the body BD. In the present invention, the human sensor is not limited to the pyroelectric sensor, and, for example, a sensor that detects infrared rays with unique waveforms reflecting on a human body can also be employed.

In FIG. 2, two drive wheels 12R and 12L are provided at the right and left edges of the bottom of the body BD. Also, at the front (in the traveling direction) of the bottom of the body BD, three auxiliary wheels 13 are disposed. In addition, at the upper right, lower right, upper left, and lower left of the bottom of the body BD, a step sensor is provided respectively that detects a step or irregularity of the floor surface. A main brush 15 is mounted lower than the center of the bottom of the body BD. The main brush 15 is rotated by a main brush motor 52 (not shown) to sweep the floor clear of dust. The opening adjacent to the main brush 15 is a suction hole through which the dust collected by the brush is sucked in. A side brush 16 is provided at the upper right and upper left of the bottom of the body BD respectively.

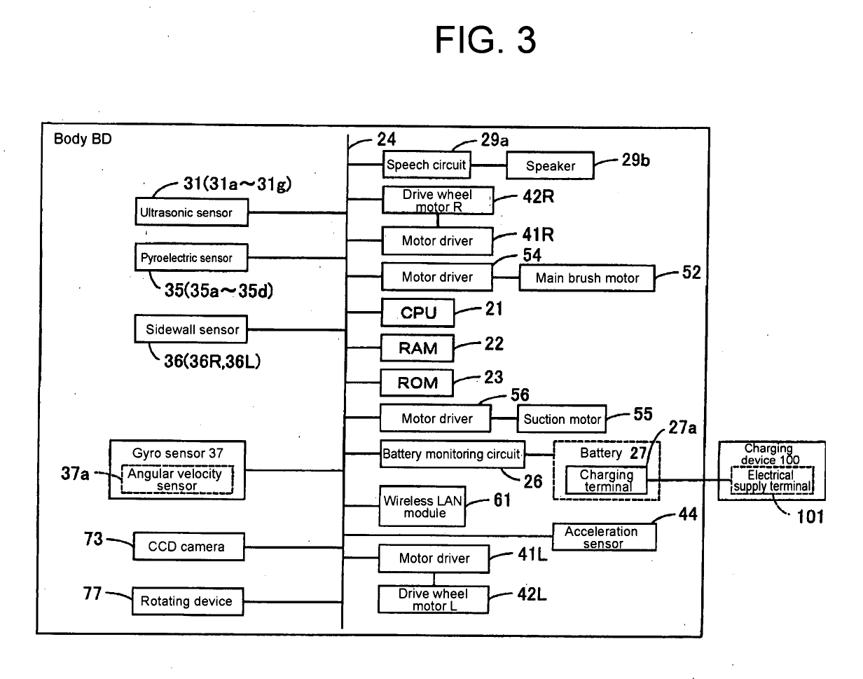

The self-propelled cleaner 10 of the present invention is equipped with various other sensors in addition to the ultrasonic sensors 31, pyroelectric sensors 35, and step sensors 14 shown in FIGS. 1 and 2. These other sensors are described below with reference to FIG. 3.

(2) Internal Configuration of the Self-Propelled Cleaner

FIG. 3 is a block diagram illustrating the configuration of the self-propelled cleaner shown in FIGS. 1 and 2. In this figure, a CPU 21, a ROM 23, and a RAM 22 are connected to the body BD through a bus 24. The CPU 21 performs various controls according to control programs and various parameter tables stored in the ROM 23, using the RAM 22 as a work area.

The body BD contains a battery 27 and the CPU 21 can monitor the remaining capacity of the battery via a battery monitoring circuit 26. Also, the battery 27 has a charging terminal 27a for charging from a charging device 100 described below. The battery 27 is charged by connecting an electrical supply terminal 101 of the charging device 100 to the charging terminal 27a. The battery monitoring circuit 26 detects the remaining capacity mainly by monitoring the voltage of the battery 27. Moreover, the body BD has an audio circuit 29a connected to the bus 24, and a speaker 29b makes a sound according to an audio signal generated by the audio circuit 29a.

Furthermore, the body BD is equipped with the ultrasonic sensors 31 (31a to 31g), the pyroelectric sensors 35 (35a to 35d) as human sensors, and the step sensors 14 (refer to FIGS. 1 and 2). In addition to these sensors, the body BD has a sidewall sensors 36R and 36L (not shown in FIGS. 1 and 2) to detect sidewalls. For the sidewall sensors 36R and 36L, for example, passive sensors or ultrasonic sensors may be employed. The body BD also has a gyro sensor 37. The gyro sensor 37 includes an angular velocity sensor to detect an angular velocity change caused by the traveling direction change of the body BD, and it is possible to detect the direction angle at which the body BD faces, by accumulating the output values of the angular velocity sensor 37a.

The self-propelled cleaner 10 of the present invention has the drive mechanism including; motor drivers 41R and 41L; drive wheel motors 42R and 42L; and a gear unit (not shown) intercalated between the drive wheel motors 42R and 42L and the drive wheels 12R and 12L. The motor drivers 41R and 41L finely control the rotation direction and rotation angle of the drive wheel motors 42R and 42L, when the self-propelled cleaner turns. Each of the motor drivers 41R and 41L outputs a drive signal corresponding to the instruction from the CPU 21. The gear unit and the drive wheels 12R and 12L may be implemented in various forms, such as circular rubber tyres or endless belts.

Furthermore, the actual rotation direction and rotation angle of the drive wheels can be detected from the output of a rotary encoder (not shown) attached integrally with the drive wheel motors 42R and 42L. Also, instead of directly coupling the rotary encoder to the drive wheels, a freely rotating driven wheel may be provided near each of the drive wheels, and the amount of rotation of the driven wheels may be fed back so that the actual amount of rotation can be detected even when the drive wheels are skidding. An acceleration sensor 44 detects the accelerations in the XYZ axial directions, and outputs the detection results. The gear unit and the drive wheels 12R and 12L may be implemented in various forms, such as circular rubber tyres or endless belts.

The cleaning mechanism of the self-propelled cleaner 10 of the present invention comprises: two side brushes 16 (refer to FIG. 2) disposed at the bottom of the body BD; a main brush 15 (refer to FIG. 12) disposed at the center of the bottom of the body BD; and a suction fan (not shown) that sucks the dust collected by the main brush 15 into the dust box 90 to store therein. The main brush 15 is driven by a main brush motor 52 and the suction fan is driven by a suction motor 55. To the main brush motor 52 and suction motor 55, driving power is supplied from motor drivers 54 and 56 respectively. The cleaning by means of the main brush 15 is controlled by the CPU 21 according to the floor condition, battery capacity, instruction from the user, and the like.

The body BD contains a wireless LAN module 61, and the CPU 21 can communicate with an external LAN according to the prescribed protocol. The wireless LAN module 61 assumes the existence of an access point, and the access point can connect to an external wide area network (for example, the Internet) via routers or the like. This makes it possible to send receive ordinary E mails via the Internet and to browse Web sites. The wireless LAN module 61 comprises a standardized card slot, a standardized wireless LAN card connected to the card slot, and the like. Of course, the card slot can accommodate other standardized cards.

Also, the body BD is provided with the CCD camera 73. The imaging signal generated by the CCD camera 73 is transmitted to the CPU 21 through the bus 24, and is processed by the CPU 21. The CCD camera 73 has an optical system capable of taking images of the front side of the body BD, and produces an electric signal according to an infrared ray input from the viewing angle realized by the optical system. Specifically, the infrared CCD sensor has a large number of photodiodes, each of which are arranged corresponding to each pixel at the image forming position of the optical system, and each photodiode generates an electric signal corresponding to the electric energy of an input visible ray. Then, the generated imaging signal is output to the CPU 21 accordingly.

(3) Operation of the Self-Propelled Cleaner

Now, the operation of the self-propelled cleaner 10 of the present invention is described.

The self-propelled cleaner 10 provides two modes: (A) automatic cleaning mode and (B) alarm mode, from which the user can select a desired mode.

(A) Automatic Cleaning Mode:

When set to the automatic cleaning mode, the self-propelled cleaner 10 performs a cleaning while automatically traveling according to the control program stored in the ROM 23 or the like. If a wall or an uneven surface of the floor is detected by the sensors, a traveling control is performed based on the control program.

(B) Alarm Mode:

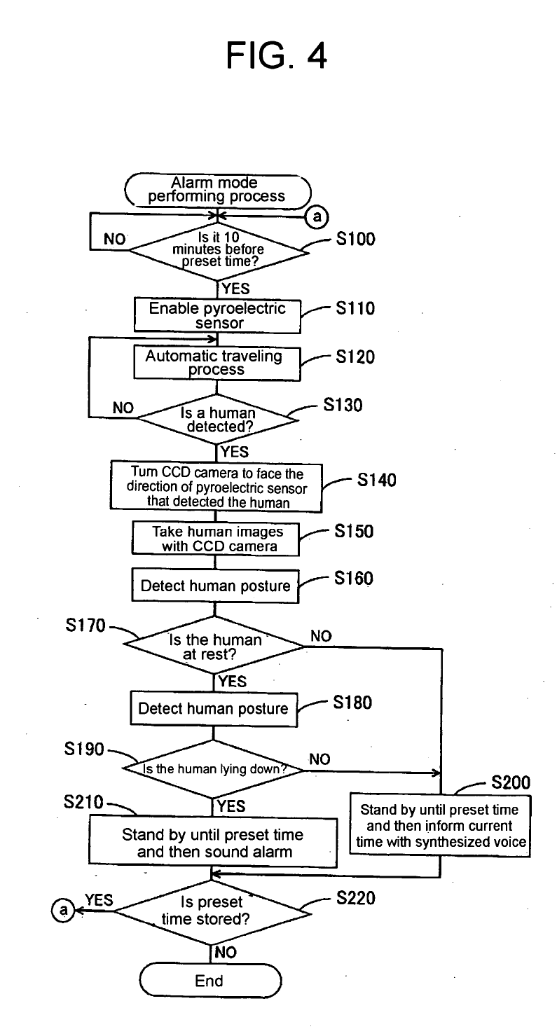

When set to the alarm mode, the self-propelled cleaner 10 stands by at rest until predetermined period of time (for example, 10 minutes) before the preset time. And, the predetermined period of time before the preset time, the self-propelled cleaner performs an automatic travel according to the control program stored in the ROM 23 or the like, and also detects a human with the pyroelectric sensors 35 (35a to 35d). If a human is detected, images of the human are taken with the CCD camera 73 and it is determined whether or not the human is sleeping. If the human is sleeping an alarm sound is made, and if the human is not sleeping the current time is informed with synthesized voice. This alarm mode will be described in more detail below with reference to FIGS. 4 to 8.

The flow of the alarm mode performing process executed by the self-propelled cleaner 10 of the present invention is described with reference to the flowchart shown in FIG. 4. The description below assumes that user-preset one or more times are stored in the RAM 22 or the like contained in the self-propelled cleaner 10. When the alarm mode performing process starts, it is determined whether or not it is 10 minutes before the preset time, at step S100. In this process, the current time is preset by the user, and it is determined whether or not it is 10 minutes before the preset time stored in the RAM 22 or the like. For example, if the time to make an alarm sound is set at 7:30, then it is determined whether or not it is 7:20 i.e., 10 minutes before the preset time.

If it is determined that it is not 10 minutes before the preset time at step S100, control is returned to step S100 to have the self-propelled cleaner standby, and if it is 10 minutes before the preset time the pyroelectric sensors are enabled at step S110. That is, each of the four pyroelectric sensors (35a to 35d) is enabled to detect infrared rays from a human body.

When the process of step S110 is finished, an automatic traveling process is carried out. In this process, according to the control program stored in the ROM 23 or the like, the drive wheel motors 42R and 42L are independently controlled via the motor drivers 41R and 41L respectively, to make the body BD automatically travel. At this time, it is possible to store the details of the room (floor area, locations of obstacles, etc.) in the self-propelled cleaner 10 and control the self-propelled cleaner to go round the room by automatic travel.

When the process of step S120 is finished, it is determined whether or not a human is detected, at step S130. That is, it is determined whether or not infrared rays emitted from a human body are detected with one of the enabled pyroelectric sensors 35a to 35d. If it is determined that a human is not detected at step S130, control is returned to step S120 to continue the automatic travel of the body BD, and if a human is detected, the process is executed for turning the CCD camera to face the direction of the pyroelectric sensor that detected the human at step S140. In this process, the body BD is stopped and then turned so that the CCD camera 73 faces the direction in which the pyroelectric sensor 35 of the four pyroelectric sensors 35 (35a to 35d), which detected the human at step S130, is disposed. For example, if the pyroelectric sensor 35a of the four pyroelectric sensors detected the human, then the body BD is turned right so that the CCD camera faces the direction in which the pyroelectric sensor 35a is disposed, i.e., the obliquely right direction ahead of the body BD. When the direction of the CCD camera is changed by the execution of the process of step S140, the human detected by the pyroelectric sensor 35 will be within the imaging range of the CCD camera 73.

When the process of step S140 is finished, the CCD camera takes images of the human at step S150. As described above, since the human is already within the imaging range of the CCD camera as a result of the process of step S140, images of the human are taken at step S150.

When the process of step S150 is finished, the process of detecting the movement of the human is performed at step S160. Specifically, the differences among the frames (a frame is one screen of imaging signal) stored in frame memory (not shown) are detected.

When the process of step S160 is finished, it is determined whether or not the human is at rest. Specifically, after the differences among the frames of the imaging signals are detected for a predetermined period of time (for example, 5 seconds) at step S160, it is determined whether or not the human is at rest for the predetermined period of time, without any movement. If it is determined that the human is not at rest at step S170, the human is awake and therefore the self-propelled cleaner stands by until the preset time, and then the process of informing the current time with synthesized voice is performed at step S200.

Whereas, if it is determined that the human is at rest at step S170, the process of detecting the posture of the human is performed at step S180. Specifically, a portion the human resembling the shape of a human body is identified by analyzing the imaging signals generated by the CCD camera 73, and it is checked if the longitudinal direction of the identified portion is vertical or horizontal. When the process of step S180 is finished, it is determined whether or not the human is lying down, at step S190. In this process, it is determined whether or not the longitudinal direction of the portion of the human, detected at step S180, is horizontal. If horizontal, the human imaged by the CCD camera 73 is lying down.

Whether or not the longitudinal direction is horizontal can be determined based on the locations of changed portions in multiple images taken at certain intervals of time. That is, if the changed portions are horizontal, the human is lying down.

When the CCD camera 73 takes images in color, it is possible to locate a flesh-colored portion in the images, and to determine that the flesh-colored portion is the location of the face. In addition, if the location of the face is near the top of the image, it is determined that the human is awake, and if near the bottom, the human is sleeping. Also, if the location of the face changed among the multiple images taken at certain intervals of time, it may be determined that the human is moving and therefore awake.

If it is determined that the human is lying down at step S190, the process of step S200 described above is performed, and after the self-propelled cleaner stands by until the preset time, the current time is informed with synthesized voice. If it is determined that the human is sleeping at step S190, the self-propelled cleaner stands by until the preset time comes, and makes an alarm sound at the preset time.

When the process of step S210 or S200 is finished, it is determined whether or not the preset time is stored, at step S220. That is, either the current time is informed at step S200, or it is determined whether or not there is a preset time stored in the RAM 22 or the like, other than that at which the alarm sound was made at step S210. If it is determined that a preset time is stored at step S220, control is returned to step S100, and if not, the alarm mode performing process is terminated.

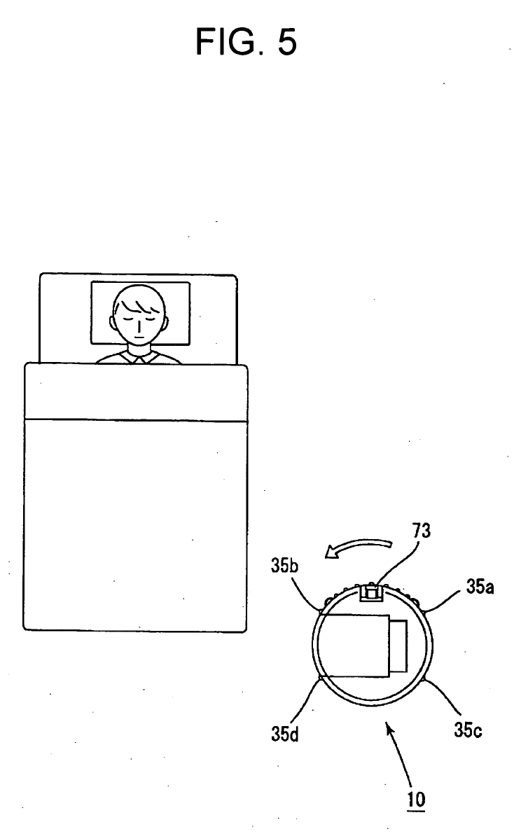

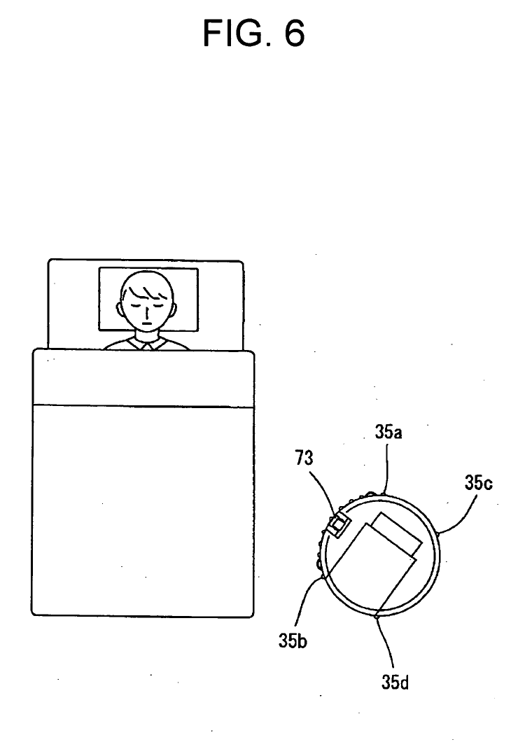

Now, a concrete example of the alarm mode performing process being executed is described with reference to FIGS. 5 to 8. Ten minutes before the preset time, each of the four pyroelectric sensors 35 (35a to 35d) is enabled (step S110) to start an automatic travel of the body BD (step S120). FIGS. 5 and 6 show the automatic travel is being performed with the four pyroelectric sensors enabled. In FIG. 5, the self-propelled cleaner 10 has come near a sleeping human while it is traveling. At this time, the human is detected by the front left pyroelectric sensor 35b of the four pyroelectric sensors 35. Then, the body BD is turned counterclockwise as shown in the outline arrow (step S140), so that the CCD camera 73 faces the human as shown in FIG. 6. That is, the body BD is turned so that the CCD camera 73 faces the direction in which the pyroelectric sensor 35b is disposed as shown in FIG. 5.

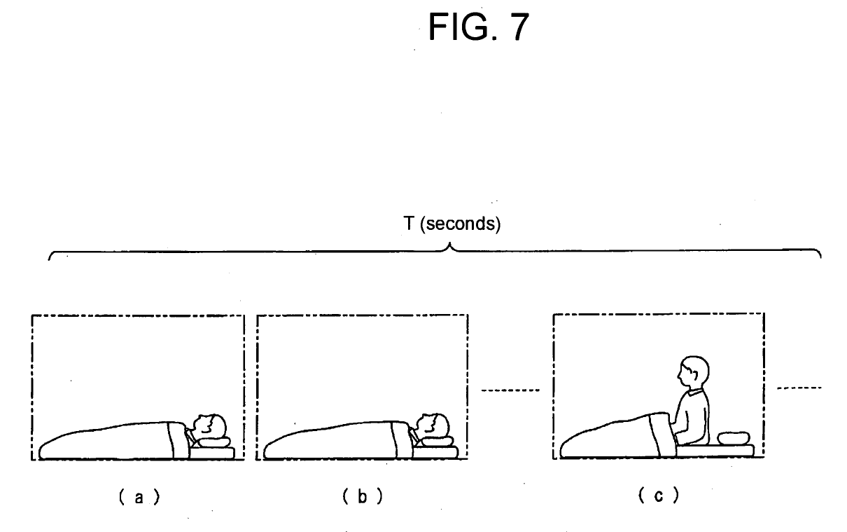

When the human enters within the imaging range of the CCD camera 73 as a result of turning the body BD, the CCD camera 73 takes images of the human (step S160), and, based on the imaging signals from the CCD camera 73, movements of the human are detected (step S160) to determine whether or not the human is at rest. FIG. 7 shows the changes in the frames of imaging signals generated by the CCD camera 73. In the figure, changes in the frames for a period of time from start of the imaging to the preset time (T), the leftmost frame (a) being the frame at the time the imaging started. In the frame (a) and the next frame (b), the human is sleeping and no movement is detected from the difference between these frames, but in the subsequent frame (c), the human sits up, which means that the movement of the human is detected. That is, in the case of FIG. 7, it is determined that the human is at rest at step S170, and the alarm sound is not made at the preset time but the current time is informed with synthesized voice (step S200) If the preset time (T) has come without any movement of the human, that is all the frames are the same as the frame (a) or (b), it is determined that the human is at rest at step S170.

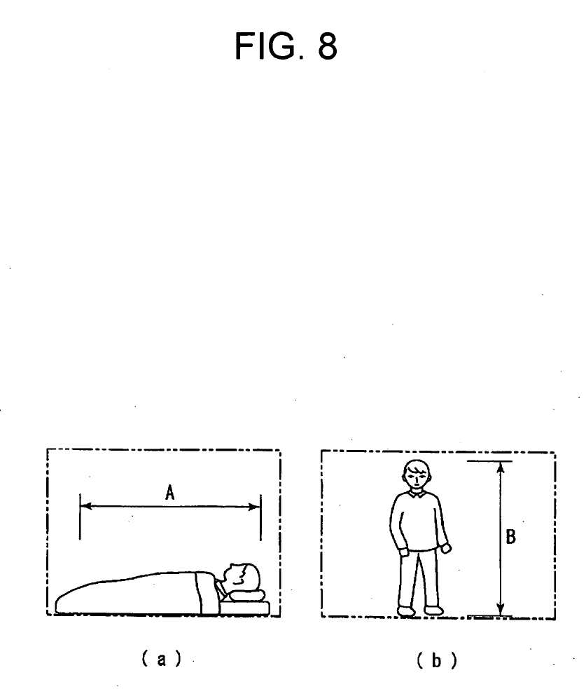

If it is determined that the human is at rest, the process of detecting the posture of the human is performed (step S180), and from the detection result, it is determined whether or not the human is lying down (step S190). FIG. 8 shows the frame in which the human is lying down and that in which he is standing. In the process of step S180, the generated imaging signals are analyzed and portions resembling the shape of a human body are identified, and at the same time, the longitudinal direction of the identified portion is detected. Then, at step S190, it is determined whether or not the longitudinal direction of the identified portion is vertical or horizontal. In the case of (a) of FIG. 8, the human is lying down and therefore it is determined that the longitudinal direction shown by the arrow A is horizontal, in the process of steps S180 and S190, and then an alarm sound is made at the preset time (step S210). In (b) of FIG. 8, on the other hand, the human is standing and therefore it is determined that the longitudinal direction shown by the arrow B is vertical, in the process of steps S180 and S190. In this case, when the preset time has come, no alarm sound is made but the current time is informed (step S200).

(4) Modifications:

In the embodiments described above, after a human is detected by the pyroelectric sensor, both the movement and posture of the human are detected based on the imaging signals generated by the CCD camera, and when it is determined that the human is at rest and lying down, the human is considered sleeping and an alarm sound is made. However, according to the present invention, it is possible to detect either of the movement and the posture of the human. For example, an alarm sound may be made only when it is determined that the human is at rest, or only when it is determined that the human is lying down.

Also, in the embodiments described above, the four human sensors (pyroelectric sensors) are disposed equiangularly, and all areas around the self-propelled cleaner body can be detected. However, according to the present invention, positions and numbers of the human sensors are not limited, and, for example, two human sensors may be disposed at both sides of the front of the body BD so that the area ahead of the body BD becomes the detectable range.

Furthermore, in the self-propelled traveling apparatus of the present invention, it is possible to provide an infrared camera using infrared ray as the imaging ray, and to detect the movement and/or posture of a human from the imaging signals based on the unique waveforms of infrared rays reflected on the human skin. This allows the images to be taken even in the dark without visible rays, thus making possible to determine whether or not the human is sleeping when an alarm is set at nighttime, and to make an alarm sound at the preset time.

Moreover, in the embodiments described above, the self-propelled traveling apparatus constituting a chargeable traveling system is a self-propelled cleaner having a cleaning mechanism. However, the self-propelled traveling apparatus according to the present invention is not limited to the self-propelled cleaner, and that without a cleaning mechanism may be implemented.

(5) Conclusion

As described above, the self-propelled cleaner according to the embodiments, when a human is detected by one of the four pyroelectric sensors 35 (35a to 35d), turns the body BD so that the CCD camera 73 faces the direction of the pyroelectric sensor 35 that detected the human, and also takes images of the human with the CCD camera 73. Then, based on the imaging signals generated by the CCD camera 73, the movement and posture of the human are detected. If it is determined that the human is at rest and also lying down, the human is considered sleeping and an alarm sound is made at the preset time. By doing this, it is possible to improve the accuracy of the determination of whether the human is sleeping or awake, and thereby to eliminate useless alarms.

The foregoing invention has been described in terms of preferred embodiments. However, those skilled in the art will recognize that many variations of such embodiments exist. Such variations are intended to be within the scope of the present invention and the appended claims.

We claim:

1. A self-propelled cleaner including a body equipped with a cleaning mechanism, a drive mechanism to steer and drive said body, and an alarm to give predetermined alarm or information at a preset time, comprising:
a plurality of human sensors to be disposed roughly equiangularly;
a camera with predetermined viewing angle; and
a sleep determination processor that, when one of said plurality of human sensors detects a human, turns said body in the direction in which said camera faces the direction of said human sensor, takes images of said human with said camera, and determines whether or not the human is sleeping, by determining if the human is lying down and/or whether or not the human is at rest, based on the imaging signals from said camera, wherein:
said alarm gives said predetermined alarm at said preset time, when said sleep determination processor has determined that the human is sleeping.

2. A self-propelled traveling apparatus including a drive mechanism to steer and drive said self-propelled traveling apparatus, and an alarm that gives a predetermined alarm or information at a preset time, comprising:
a human sensor;
a camera with predetermined viewing angle; and
a sleep determination processor that, when said human sensor detects a human, takes images of said human with said camera, and determines whether or not the human is sleeping, based on the imaging signals from said camera, wherein:
said alarm gives said predetermined alarm at said preset time, when said sleep determination processor has determined that the human is sleeping.

3. The self-propelled traveling apparatus according to claim 2, wherein said sleep determination processor determines whether or not the human is sleeping, by determining whether or not the human is lying down, based on the imaging signals from said camera.

4. The self-propelled traveling apparatus according to claim 2, wherein said sleep determination processor determines whether or not the human is sleeping, by determining whether or not the human is at rest, based on the imaging signals from said camera.

5. The self-propelled traveling apparatus according to claim 2, wherein:
a plurality of said human sensors are provided and disposed roughly equiangularly; and
said sleep determination processor, when taking images of the human, turns said body so that said camera faces the direction in which a human sensor of said plurality of human sensors that detected the human is disposed.

6. The self-propelled traveling apparatus according to claim 2, which is a self-propelled cleaner having a cleaning mechanism.

7. The self-propelled traveling apparatus according to claim 2, wherein said human sensor has a pyroelectric sensor that detects a human located in the vicinity of said body, by detecting infrared rays emitted from a human body, and can detect the entire area around said body.

8. The self-propelled traveling apparatus according to claim 2, wherein:
said drive mechanism comprises motor drivers, drive motors, drive wheels, and gear units disposed between said drive motors and drive wheels;
the rotation direction and rotation angle of said drive wheel motors are finely controlled by said motor drivers when said body is turned; and
each motor driver outputs corresponding drive signals according to control instructions.

9. The self-propelled traveling apparatus according to claim 2, wherein:
said camera has an optical system capable of imaging the front side of said self-propelled traveling apparatus;
a CCD camera is provided that generates electric signals according to visual rays input from the field of view realized by said optical system; and
imaging signals generated by said CCD camera are transmitted to a predetermined main control circuit through a bus, to process said imaging signals at said main control circuit.

10. The self-propelled cleaner according to claim 8, wherein:
said sleep determination processor, when it is determined that it is a predetermined period of time before the time set in said alarm, enables said pyroelectric sensor to allow each pyroelectric sensor to detect infrared rays emitted from a human body.

11. The self-propelled cleaner according to claim 8, wherein:
said drive mechanism allows an automatic traveling process in which said self-propelled cleaner is controlled to store the details of the room and go round the room automatically; and
in said automatic traveling process, said body is moved automatically by controlling, through said motor drivers, each of said drive wheel motors independently according to a control program stored in a predetermined ROM.

12. The self-propelled traveling apparatus according to claim 5, wherein said body is turned so that said camera faces the direction of a human sensor of said plurality of human sensors that detected the human.

13. The self-propelled traveling apparatus according to claim 4, wherein:
determination of whether or not the human is at rest is made by determining whether or not there has been any movement of the human for a predetermined period of time, after the differences among the frames of the imaging signals were detected over said predetermined period of time.

14. The self-propelled traveling apparatus according to claim 3, wherein said sleep determination processor analyzes the imaging signals generated by said camera, identifies a portion resembling the shape of a human body, and checks if the longitudinal direction of the identified portion is vertical or horizontal.

15. The self-propelled traveling apparatus according to claim 14, wherein said sleep determination processor determines whether or not the longitudinal direction of the portion resembling the shape of a human body is vertical or horizontal, and if horizontal, it is determined that the human imaged by said camera is lying down.

16. The self-propelled traveling apparatus according to claim 3, wherein said sleep processor, when said camera takes images in color, locates a flesh-colored portion in the images and determines that the location of the flesh-colored portion is the face of the human, and if the flesh-colored portion is near the top of the images, determines that the human is sitting up, and if the flesh-colored portion is near the bottom of the image, determines that the human is lying down.
